(19) United States
(12) Patent Application Publication
(10) Pub. No.: US 2026/0230254 A1
(43) Pub. Date: Aug. 6, 2026

(54) ADAPTING TO SIGNAL LOSS IN A FRONTHAUL LINK BASED ON A REFERENCE METRIC

(71) Applicant: Telefonaktiebolaget LM Ericsson (publ), Stockholm (SE)

(72) Inventors: Eduardo LINS DE MEDEIROS, Sundbyberg (SE); Igor Mesquita DE ALMEIDA, Indaiatuba-SP (BR); Per-Erik ERIKSSON, Stockholm (SE); Gyanesh PATRA, Järfälla (SE)

(21) Appl. No.: 19/150,689

(22) PCT Filed: Jan. 24, 2023
(86) PCT No.: PCT/SE2023/050057

§ 371 Date: Jul. 24, 2025

(51) Int. Cl. H04L 5/00; H04B 7/06; H04B 17/309

(52) U.S. Cl. CPC H04L 5/0048; H04B 7/0626; H04B 17/346

(57) ABSTRACT

It is provided a method for adapting to signal loss in a fronthaul link between a baseband node and a radio node of a radio access network. The method is performed in a signal loss adjuster. The method comprises: obtaining a loss metric, the loss metric indicating loss of pilot signals over the fronthaul link in a measurement interval; obtaining a reference metric, based on the loss metric, the reference metric indicating expected impact on at least one reception quality indicator in a receiver based on the loss of pilot signals; obtaining a reception quality indicator, indicating quality of reception over radio of the pilot signals; and adapting a result from the reception quality indicator based on the reference metric.

### TECHNICAL FIELD

The present disclosure relates to the field of fronthaul links in a radio communication network and in particular to adapting to signal loss in a fronthaul link.

### BACKGROUND

In order to meet the increasing demand for data in recent mobile broadband networks (such as 5G systems), innovative and practical deployment solutions are required. For instance, 5G systems support network interfaces in a Centralized/Cloud Radio Access Network (C-RAN) architecture. Such interfaces support splitting of radio access functionality between a remote radio node and a baseband node.

The connection between the baseband node and the remote node is referred to as a fronthaul link or fronthaul network. A commonly used interface over the fronthaul link is evolved Common Public Radio Interface (eCPRI). The fronthaul link can be used to carry baseband radio samples in packets, allowing the use of high volume, relatively low-cost Ethernet transceivers. Compression methods may be used in order to lower fronthaul bandwidth requirements.

The fronthaul links can be based on Internet Protocol (IP) or are bridged networks and can experience packet loss, e.g. due to congestion. An implicit effect of packet loss is that fronthaul issues may lead to longer term radio capacity impact. This is due to radio interface control mechanisms, such as link adaptation (LA), acting on the data loss as if the data loss was due to radio interface issues, even though the data loss was independent of radio conditions. An implication of this is that it can lead to unnecessarily conservative modulation and coding, and thus lower throughput than necessary.

Specifically, fronthaul packet losses can result in mismatch in radio channel estimation/channel quality feedback, which results in the receiving node in the radio access network perceiving the radio channel as worse than it is due to loss of pilot signals in fronthaul.

### SUMMARY

One object is to improve link adaptation when packet loss occurs in a fronthaul link.

According to a first aspect, it is provided a method for adapting to signal loss in a fronthaul link between a baseband node and a radio node of a radio access network. The method is performed in a signal loss adjuster. The method comprises: obtaining a loss metric, the loss metric indicating loss of pilot signals over the fronthaul link in a measurement interval; obtaining a reference metric, based on the loss metric, the reference metric indicating expected impact on at least one reception quality indicator in a receiver based on the loss of pilot signals; obtaining a reception quality indicator, indicating quality of reception over radio of the pilot signals; and adapting a result from the reception quality indicator based on the reference metric.

The adapting may comprise determining a degradation of the reception quality indicator, further than what is indicated by the reference metric, as a radio interface degradation.

The adapting may comprise adjusting the reception quality indicator to correspond to the radio interface degradation.

The obtaining a loss metric may be based on a receiver node in the fronthaul link comparing successfully received pilot signals with pilot signals that were scheduled to be received by the receiver.

The reference metric may be based on any of the following: a signal-to-noise ratio, a channel quality indicator, a rank indicator, a pilot signal received power, and a precoder indicator.

The method may further comprise: providing the adapted result to a link adaptation module.

The pilot signal may be a downlink transmission, and the obtaining a reception quality indicator may comprise obtaining the reception quality indicator from a user equipment.

The pilot signal may be a channel state information reference signal, CSI-RS, a cell specific reference, CRS, signal or a synchronization signal block.

The pilot signal may be an uplink transmission, and the obtaining a reception quality indicator may comprise obtaining the reception quality indicator from the baseband node.

The pilot signal may be a sounding reference signal, SRS, or a demodulation reference signal, DMRS.

According to a second aspect, it is provided a signal loss adjuster for adapting to signal loss in a fronthaul link between a baseband node and a radio of a radio access network. The signal loss adjuster comprises: a processor; and a storing instructions that, when executed by the processor, cause the signal loss adjuster to: obtain a loss metric, the loss metric indicating loss of pilot signals over the fronthaul link in a measurement interval; obtain a reference metric, based on the loss metric, the reference metric indicating expected impact on at least one reception quality indicator in a receiver based on the loss of pilot signals; obtain a reception quality indicator, indicating quality of reception over radio of the pilot signals; and adapt a result from the reception quality indicator based on the reference metric.

The instructions to adapt may comprise instructions that, when executed by the processor, cause the signal loss adjuster to determine a degradation of the reception quality indicator, further than what is indicated by the reference metric, as a radio interface degradation.

The instructions to adapt may comprise instructions that, when executed by the processor, cause the signal loss adjuster to adjust the reception quality indicator to correspond to the radio interface degradation.

The instructions to obtain a loss metric may be based on a receiver node in the fronthaul link comparing successfully received pilot signals with pilot signals that were scheduled to be received by the receiver.

The reference metric may be based on any of the following: a signal-to-noise ratio, a channel quality indicator, a rank indicator, a pilot signal received power, and a precoder indicator.

The signal loss adjuster may further comprise instructions that, when executed by the processor, cause the signal loss adjuster to: provide the adapted result to a link adaptation module.

The pilot signal may be a downlink transmission, and the instructions to obtain a reception quality indicator may comprise instructions that, when executed by the processor, cause the signal loss adjuster to obtain the reception quality indicator from a user equipment.

The pilot signal may be a channel state information reference signal, CSI-RS, a cell specific reference, CRS, signal or a synchronization signal block.

The pilot signal may be an uplink transmission, and the instructions to obtain a reception quality indicator may comprise instructions that, when executed by the processor, cause the signal loss adjuster to obtain the reception quality indicator from the baseband node.

The pilot signal may be a sounding reference signal, SRS, or a demodulation reference signal, DMRS.

According to a third aspect, it is provided a computer program for adapting to signal loss in a fronthaul link between a baseband node and a radio node of a radio access network. The computer program comprises computer program code which, when executed on a signal loss adjuster causes the signal loss adjuster to: obtain a loss metric, the loss metric indicating loss of pilot signals over the fronthaul link in a measurement interval; obtain a reference metric, based on the loss metric, the reference metric indicating expected impact on at least one reception quality indicator in a receiver based on the loss of pilot signals; obtain a reception quality indicator, indicating quality of reception over radio of the pilot signals; and adapt a result from the reception quality indicator based on the reference metric.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating a cellular communication network where embodiments presented herein may be applied;

FIGS. 2A-C are schematic diagrams illustrating embodiments of where the signal loss adjuster can be implemented;

FIG. 3 is a swimlane diagram illustrating embodiments of methods for adapting to signal loss in a fronthaul link based on a downlink pilot signal;

FIG. 4 is a swimlane diagram illustrating embodiments of methods for adapting to signal loss in a fronthaul link based on an uplink pilot signal;

FIGS. 5A-B are flow charts illustrating embodiments of methods for adapting to signal loss in a fronthaul link between a baseband node and a radio node of a radio access network;

FIG. 6 is a schematic diagram illustrating components of the signal loss adjuster of FIGS. 2A-C;

FIG. 7 is a schematic diagram showing functional modules of the signal loss adjuster of FIGS. 2A-C according to one embodiment; and

FIG. 8 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, the robustness of radio link adaptation is improved for systems where a baseband node and a radio node are connected by packet-based fronthaul link. Packet losses in the fronthaul link are detected, and the resulting loss of pilot signal information is quantified in a signal loss metric. The loss metric is used to adjust uplink or downlink channel quality estimates due to the loss of pilot signals, avoiding degradation of throughput caused by mismatch in link adaptation. This can be applied both in downlink and uplink.

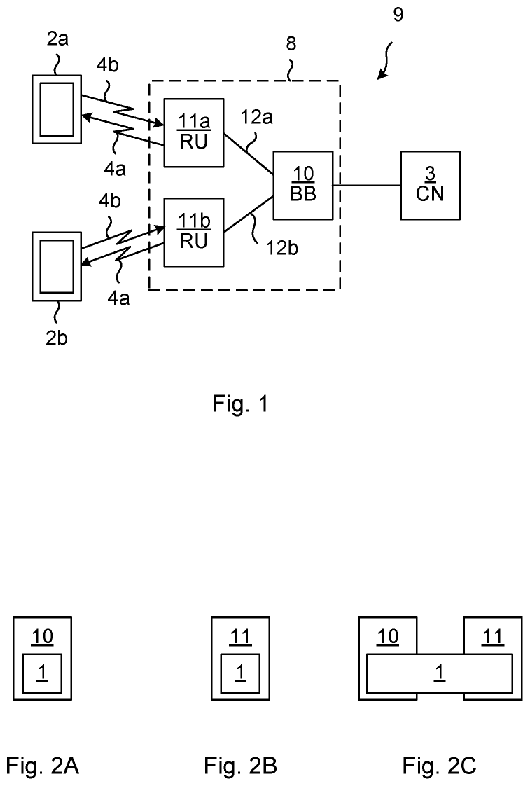

FIG. 1 is a schematic diagram illustrating a cellular communication network 9 where embodiments presented herein may be applied. The cellular communication network 9 comprises a core network 3 and one or more radio network nodes 8 (also known as base stations) part of a radio access network (RAN).

The radio network nodes can be the form of radio base stations being gNode Bs, gNBs, or evolved Node Bs, also known as eNode Bs or eNBs. The radio network nodes could also be in the form of Node Bs, BTSs (Base Transceiver Stations) and/or BSSs (Base Station Subsystems), etc. The radio network node 8 provides radio connectivity over a wireless interface 4a-b to a plurality of UEs (User Equipment) 2a-b. The radio network node can be implemented by at least one O-DU (O-RAN(Open RAN)distributed unit) and at least one O-RU (O-RAN radio unit).

Over the wireless interface, downlink (DL) communication 4a occurs from the radio network node 8 to the UEs 2a-b and uplink (UL) communication 4b occurs from the UEs 2a-b to the radio network node 8. The quality of the wireless radio interface to each UE 2a-b can vary over time and depending on the position of the UE 2a-b, due to effects such as fading, multipath propagation, interference, etc.

The radio network node 8 can comprise several antennas, e.g. in a MIMO antenna array to thereby enable beamforming to the UEs 2a-b by applying beamforming coefficients, respectively for each one of the antennas. The beamforming can be applied separately for each UE 2a-b or simultaneously for multiple UEs. The beamforming can be applied in downlink 4a and/or uplink 4b. A beam index defines the beamforming coefficients and may correspond to a direction from the radio to network node 8. Also, UL and/or DL beamforming from/to the UE is possible.

The term UE is also known as mobile communication terminal, user device, mobile terminal, user terminal, user agent, wireless device, wireless terminal, machine-to-machine device etc., and can be, for example, what today are commonly known as a mobile phone, smart phone or a tablet/laptop with wireless connectivity.

The cellular communication network 9 may e.g. comply with any one or a combination of 5G NR (New Radio), LTE (Long Term Evolution), LTE-Advanced, 6G (sixth generation), W-CDMA (Wideband Code Division Multiplex), or any other current or future wireless network, as long as the principles described herein are applicable.

The radio network node 8 is connected to the core network 3 for connectivity to network central functions and a wide area network, such as the Internet.

The radio network node 8 is here implemented in a distributed fashion, e.g. using a C-RAN (Centralised/Cloud Radio Access Network) architecture. The radio network node 8 comprises a baseband node 10 being a baseband processing unit and one or more (in this example two) remote radio nodes 11a-b. When applied in an O-RAN architecture, the baseband node can be an O-DU node and the radio node can be an O-RU node. The baseband node 10 and the radio nodes 11a-b can be in different locations. The baseband node 10 is located uplink from the radio nodes 11a-b, i.e. towards the core network 3. Consequently, the radio nodes 11a-b are located downlink from the baseband node 10, towards the UEs 2a-b. There are respective fronthaul links 12a-b between the baseband node 10 and the radio nodes 11a-b. The fronthaul links 12a-b are bidirectional communication links. The fronthaul links 12a-b can be implemented using a Common Public Radio Interface (CPRI) or eCPRI (evolved CPRI) and Ethernet. Multiple fronthaul links can be employed in other topologies than what is shown in FIG. 1. Multiple fronthaul links can also be denoted a fronthaul network. The baseband node 10 and the radio nodes 11a-b can each implement subsets of functionality for radio communication with the UEs 2a-b. Furthermore, some functionality for the radio communication can be virtualized, also known as cloud RAN (Radio Access Network).

Although the fronthaul links 12a-b in FIG. 1 are indicated as point-to-point links between the baseband node 10 and the respective RU is should be understood that the fronthaul topology can be of ring form or other topography connecting several baseband units 10 to a respective plurality of radio units 11, and the capacity of the fronthaul be shared in a multiplexing fashion.

Both user plane data and control plane data are transmitted over radio 4a/4b and the fronthaul links 12a-b. As known in the art per se, pilot signals are sent in the control plane uplink 4b and in the downlink 4a to allow evaluation of the radio interface. Pilot signals are also known as reference signals. Examples of pilot signals in the uplink 4b are sounding reference signal (SRS) or a demodulation reference signal (DMRS). Examples of pilot signals in the downlink 4g are channel state information reference signal (CSI-RS), a cell-specific reference signal (CRS) or a synchronization signal block (SSB).

A short description of feedback-loop link adaptation is now provided. In LTE and NR, the RAN scheduler selects a modulation order and coding scheme (MCS) as well as which resource blocks to use to transmit data to/from a certain UE Over the radio interface. A measure of the radio channel quality as well as other parameters can be used to determine an MCS that e.g. maximizes throughput given a target (acceptable) error rate.

The channel quality measurement may be performed by the UE (based on downlink pilot signals) or the base station (based on uplink pilot signals). The channel quality measurements can be affected by several factors. One factor is measurement age (how long time it takes between pilot signal transmission to when the evaluation of the measurement is available to the link adaptation process). Another factor is UE mobility. Another factor is imperfections in estimation, such as limited reciprocity in transmit receive radio chains, errors in calibration, sub-optimal algorithms implementations, etc. Another factor is quantization. Usually, for measurements performed by the UE, the outcome is reported in a quantized fashion, such as a CQI (Channel Quality Indicator) report, which comprises an integer indicating the channel quality. Such quantization causes inherent loss of precision.

One way to address the uncertainty and limited availability of channel quality information is to use a feedback-loop (also known as outer-loop) adjustment for the link adaptation process. The entity that performs LA tracks the outcome of previous transmissions, and adds or subtracts a quantity from the channel quality information reported by the UE (or obtained by the base station). In this way, if the measurement is pessimistic, the feedback-loop adjustment would push it up, while if the measurements are over-optimistic it would correct it downwards. For instance, when the channel quality reported by the UE suffers from quantization errors, the base station can estimate signal-to-interference-plus-noise ratio (SINR) based on the quantized CQI.

The UE provides HARQ (hybrid automatic repeat request) feedback in the form of ACK (acknowledgement) or NACK (non-acknowledgement) to the base station. The feedback loop adjustment calculation adds or subtracts a small quantity for each successful (ACK) or failed (NACK) decoding outcome, as reported by the UE. It may also accumulate these adjustments and convert to proper units, to for example, increase or decrease the overall estimate of the SINR the UE experiences (in dB). This is then used as an input to MCS selection. However, traditional feedback-loop link adaptation does not differentiate between losses due to fronthaul packet loss and RAN issues.

As described in more detail below, according to embodiments presented herein, losses on the fronthaul link are detected and are used to determine a reference metric. The reference metric is then used to adjust results from pilot signal measurements, such that the results from the pilot signal measurements reflect radio transmission, and not losses over the fronthaul link. This allows the link adaptation to be correctly based on the radio environment, and not the fronthaul link performance (or lack thereof).

FIGS. 2A-C are schematic diagrams illustrating embodiments of where the signal loss adjuster 1 can be implemented.

In FIG. 2A, the signal loss adjuster 1 is shown implemented in the baseband node 10. The baseband node 10 is thus the host device for the signal loss adjuster 1 in this implementation. It is to be noted that the baseband node 10 itself can be virtualised and can be located in an arbitrary physical device, or even split over several physical devices.

In FIG. 2B, the signal loss adjuster is shown implemented in the radio node 11. The radio node 11 is thus the host device for the signal loss adjuster 1 in this implementation.

In FIG. 2C, the signal loss adjuster 1 is shown implemented partly in the baseband node 10 and partly in radio node 11. Both the baseband node 10 and the radio node 11 are thus host devices for the signal loss adjuster 1 in this implementation.

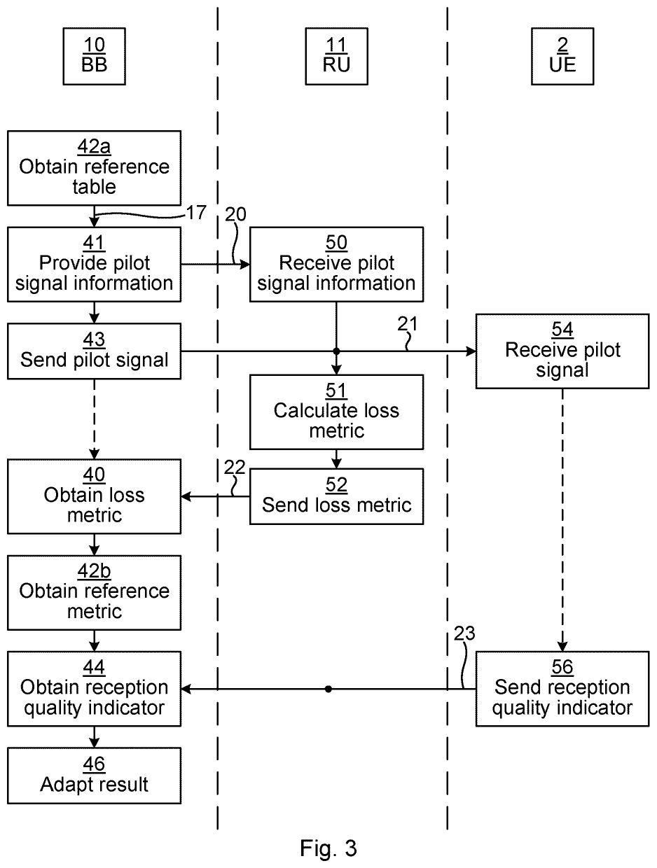

FIG. 3 is a swimlane diagram illustrating embodiments of methods for adapting to signal loss in a fronthaul link 12a-b based on a downlink pilot signal.

Communication between the baseband node 10, the radio node 11 (e.g. one of the radio nodes 11a-b of FIG. 1), and a UE 2 is also shown.

The baseband node 10 first obtains 42a a table of reference metrics. The table of reference metrics can e.g. relate a pilot loss metric to a value indicating change of quality in a measurement quantity for a certain loss of pilot signals in the fronthaul.

Each reference metric can indicate an absolute value of a reference metric type or can be a change that should be applied to a reference metric type.

Examples of pilot loss metric include:
a ratio between how many pilot signals were effectively received by the radio node 11 from the baseband node 10 during a time interval and how many pilot signals were transmitted from the baseband node 10.
The number of pilot signals lost in transit between the baseband node 10 and the radio node 11 Pilot signals refer to either a modulated (complex-valued) symbol or to an index to a constellation point (e.g. integer, binary word).

Examples of reference metrics include:
A change or absolute value of SINR caused by measuring the same channel conditions with or without pilot losses in the fronthaul.
A change or absolute value of CQI caused by measuring the same channel conditions with or without pilot losses in the fronthaul.
A change or absolute value of in rank (e.g. channel matrix rank, RI (rank indicator) caused by measuring the same channel conditions with or without pilot losses in the fronthaul
A change or absolute value of RSRP (reference signal received power) caused by measuring the same channel conditions with or without pilot losses in the fronthaul.
A change or absolute value in precoder choice (e.g. PMI (precoder matrix indicator)) caused by measuring the same channel conditions with or without pilot losses in the fronthaul.
A change or absolute value in a beam indication, such as a beam index or beam number, caused by measuring the same channel conditions with or without pilot losses in the fronthaul.

The table of reference metrics can e.g. be generated using physical layer simulation (link-level simulation), where the same channel and noise realizations can be used to calculate a measurement (e.g. an SINR measurement) with a pristine set of pilot signals and with a set of pilots in which a subset has been suitably modified to reflect losses in fronthaul (e.g. 10% loss of pilot signal resources, substituted by a default value, such as 0).

The table of reference metrics can be generated once and used for multiple sessions of result adaption based on fronthaul pilot signal losses. The table of reference metrics 17 is then provided for later processing.

The baseband node 10 then provides 41 pilot signal information 20 to the radio node 11, whereafter the radio node 11 receives 50 the pilot signal information 20.

The pilot signal information contains information about which resource elements in a time-frequency-space OFDMA (orthogonal frequency-division multiple access) grid the pilot signals of interest occupy. This information is available to the baseband node 10. It is to be noted that all scheduling information is not necessary for the purposes presented herein, but only the part indicating the position (in time, frequency, space if applicable) of pilot signals of interest.

The baseband node 10 sends 43 a downlink pilot signal 21, via the radio node 11 to the UE 2. The UE 2 thereby receives 54 the pilot signal 21.

Since the pilot signal 21 passes via the radio node 11, the radio node 11 can calculate 51 a loss metric (of the pilot signal over the fronthaul) by comparing received pilot signals with the pilot signal information 20. The radio node 11 calculates the loss metric over the set of pilot signals of interest (e.g. CSI-RS, SS block) for a certain interval.

Examples of interval include one or more slots, one or more OFDM symbols, one or more subframes.

The loss metric can be associated with a specific antenna port or other spatial entity, e.g. one loss metric per antenna port, one loss metric for a set of antenna ports (including the set of all antenna ports).

The radio node 11 then sends 52 the loss metric 22 to the baseband node 10. In association with the loss metric 22, the radio node 11 can specify: one or more loss metric values, associated time interval/entity (e.g. frame number, slot number, symbol number), associated antenna port(s) (if applicable).

The baseband node 10 obtains 40 the loss metric 22 by receiving the loss metric 22 from the radio node 11.

The baseband node 10 obtains 42b a reference metric by finding a reference metric in the table of reference metrics that corresponds to the loss metric 22.

The UE 2 determines a reception quality indicator based on the reception (over radio) of the pilot signal 21, according to instructions (from the base station) on what pilot signals to measure. In other words, the UE2 measures reception measurements of the pilot signals 21 and determines the reception quality indicator based on the reception measurements. The reception quality indictor can comprise any one or more of a CQI, RI, PMI, etc. The UE then sends 56 the reception quality indicator(s) 23 to the baseband node 10, via the radio node 11.

The baseband node 10 obtains 44 the reception quality indicator(s) by receiving the reception quality indicator from the UE 2 via the radio node 11. It is to be noted that multiple UEs may have been instructed to measure on the same set of pilot signals.

The baseband node 10 then adapts 46 the result of the reception quality indicator. The amount of adjustment of the adaptation is based on the obtained reference metric (which in turn is based on the loss metric 22, indicating the loss of pilot signals over the fronthaul, as explained above).

If it is not possible to adjust the measurement quantity directly, the baseband node 10 may choose a fail-safe value from the reference metric table. The idea is to cover cases where the loss is severe, and we need to select a safe value that might not be derived from the measurement. For instance, suppose all pilot signals are lost, in which case the reference metric table can have an entry for this situation. Consider e.g. CQI, where a fail-safe choice for CQI would be to select CQI. Another example is for beams, where a fail-safe choice for a beam selection would be to transmit on a wide beam.

One example includes selecting a precoder that differs from the one suggested by the UE as the best, in case the pilot loss exceeds a threshold, since the loss is (to a large extent) on the fronthaul and not on the radio interface.

Another example includes selecting a wide beam instead of a narrow beam indicated from the UE when the pilot loss exceeds a threshold, again since the loss is (to a large extent) on the fronthaul and not on the radio interface.

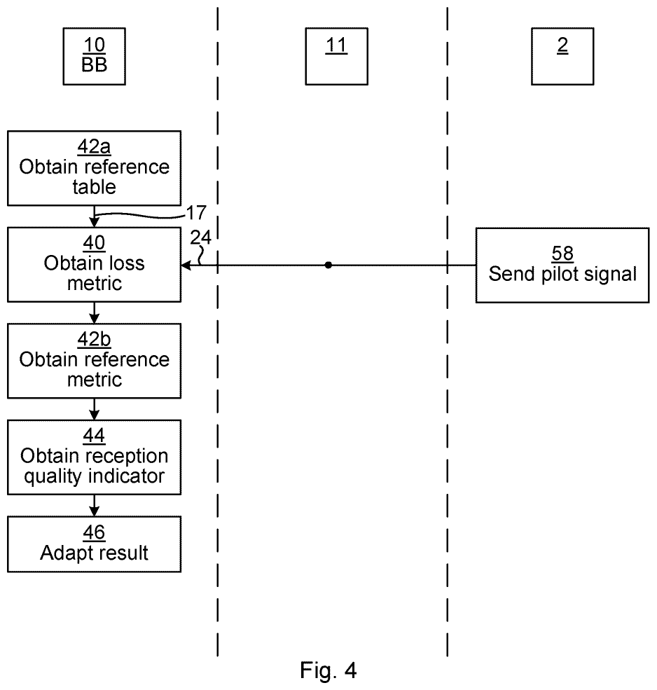

FIG. 4 is a swimlane diagram illustrating embodiments of methods for adapting to signal loss in a fronthaul link 12a-b based on an uplink pilot signal.

Communication between the baseband node 10, the radio node 11 (e.g. one of the radio nodes 11a-b of FIG. 1), and a UE 2 is also shown.

The baseband node 10 first obtains 42a a table of reference metrics, in the same manner as for the downlink case described above. Again, the table of reference metrics 17 can be used for multiple sessions of the later processing.

The UE 2 sends 58 an uplink pilot signal 24, via the radio node 11 to the baseband node 10.

The baseband node 10 obtains 40 a loss metric 22, determined by the baseband node 10 based on the received pilot signal 24. The loss metric is calculated over a set of pilot signals (e.g. SRS or DMRS) of interest for a certain interval. Examples of interval include one or more slots, one or more OFDM symbols, one or more subframes. The baseband node 10 determines the number of pilot signal that are lost on the fronthaul, based on knowledge of what have been received by the radio node 11 but are not received by the baseband node 10. The loss metric can thereby be derived based on the pilot signals that were lost on the fronthaul.

The pilot loss metric may be associated with an antenna port or other spatial entity, e.g. one pilot loss metric per antenna port, one pilot loss metric for all antenna ports.

It is to be noted that the scheduling information, including scheduling of uplink pilot signals, is available at the baseband node 10, to be able to determine the loss metric of the pilot signals.

The baseband node 10 obtains 42b a reference metric, from the table of reference metrics, based on the loss metric.

The baseband node 10 obtains 44 a reception quality indicator by determining the reception quality indicator based on the received uplink pilot signal.

The baseband node 10 then adapts 46 the result of the reception quality indicator. The amount of adjustment of the adaptation is based on the obtained reference metric (which in turn is selected from the table of reference metrics 17 based on the loss metric, indicating the loss of pilot signals over the fronthaul, as explained above).

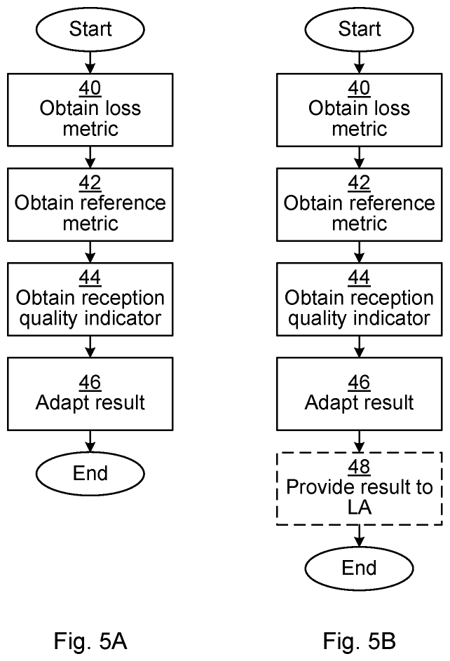

FIGS. 5A-B are flow charts illustrating embodiments of methods for adapting to signal loss in a fronthaul link 12a-b between a baseband node 10 and a radio node 11, 11a-b of a radio access network 8. The method being performed in a signal loss adjuster 1. First, embodiments of methods illustrated by FIG. 5A will be described. The embodiments illustrated by FIGS. 5A-B collectively reflect the embodiments of FIG. 3 (for the downlink pilot signals) and FIG. 4 (for the uplink pilot signals), unless explicitly indicated otherwise.

In an obtain loss metric step 40, the signal loss adjuster 1 obtains a loss metric 21. The loss metric indicates a loss of pilot signals 21, 24 over the fronthaul link 12a-b in a measurement interval.

The loss metric can be based on a receiver node 10, 11, 11a-b in the fronthaul link 12a-b comparing successfully received pilot signals with pilot signals that were scheduled to be received by the receiver.

For downlink pilot signals, such a comparison can be performed by the radio node 11.

For uplink pilot signals, the processing is slightly different. The baseband node 10 schedules a UE to transmit uplink pilot signals (e.g. SRS). The UE transmits these as instructed. The radio node 11 performs some processing and encapsulates the resource elements carrying pilot signals in packets (e.g. a sequence of complex numbers). When there is packet loss in the fronthaul, those resource elements will never be delivered to the baseband node 10. For instance, resource elements 0 to 40 are delivered to the baseband node, but resource elements 40 to 51 are missing.

In case there is e.g. fading over the air, the content of the resource elements may carry low energy, but the resource elements would be delivered to the baseband node 10 (and should be considered for link adaptation, since they correspond to reality in that channel).

Hence, the detection/loss metric calculation can be considered to be performed by noting the absence of certain resource elements that were expected to be received.

In an obtain reference metric step 42, the signal loss adjuster 1 obtains a reference metric, based on the loss metric. The reference metric indicates expected impact on at least one reception quality indicator 22 in a receiver based on the loss of pilot signals. As explained above, the reference metric can e.g. be obtained from a pre-populated table of reference metrics.

The reference metric can be based on any of the following: a signal-to-noise ratio, a channel quality indicator, a rank indicator, a pilot signal received power, and a precoder indicator. Furthermore, the reference metric could be based on any of: channel measurement (channel estimation), channel rank and precoder choice. These are measurements that the baseband node 10 itself performs on uplink pilots.

In an obtain reception quality indicator step 44, the signal loss adjuster 1 obtains a reception quality indicator 22, indicating quality of reception over radio of the pilot signals.

When the pilot signal is a downlink transmission, this step comprises obtaining the reception quality indicator from a user equipment. The pilot signal can then be a a CSI-RS, a CRS, or an SSB. The reception quality indictor can comprise any one or more of a CQI, a RI, a PMI, etc.

When the pilot signal is an uplink transmission, this step comprises obtaining the reception quality indicator from the baseband node 10 (optionally internally when the signal loss adjuster 1 is implemented in the baseband node 10). In this case, the pilot signal can be an SRS, or a DMRS and the reception quality indictor is an evaluation of the received SRS and/or DMRS.

Some processing of uplink pilots can also be performed like SRS or DMRS channel estimation, whereby this estimation is sent to the base band, per sub-band or wideband. In some functional splits, the radio node performs channel estimation, or some other pre-processing of the uplink pilot signals. It then sends the processed outcome to the baseband node 10. In this case we, can also detect the loss and calculate a loss metric, applying some correction.

In an adapt result step 46, the signal loss adjuster 1 adapts a result from the reception quality indicator 22 based on the reference metric. When the pilot signal is a downlink pilot signal, this can e.g. imply an adapted CQI, RI, PMI, etc.

When the pilot signal is an uplink pilot signal, the baseband node 10 can use those in two ways-for UL link adaptation and for DL link adaptation (reciprocity-based transmission). In UL, the baseband node 10 takes the pilot signals and can choose an MCS, rank and best beam/precoder. It can also use the pilot signal to decide where and how much to schedule further UL transmissions for that UE. For UL pilot signals, we do not use the language RI, PMI because those define the indicator-that is the message the UE uses to signal its preferred configuration. When the baseband node 10 does the processing (i.e. is the receiver of the UL pilot signal), everything is local to the baseband node 10 and it can compute everything with high precision. For instance, the baseband node 10 can estimate the SINR directly without quantization or waiting for feedback. The baseband node 10 can of course calculate the rank and beamforming coefficients locally as well. When reciprocity-based transmission is used, the baseband node 10 can use the UL pilot signals to select an MCS, to calculate a precoder (not restricted to the codebook ones) for DL. The baseband node 10 can select where and how many resources to use for the next DL transmission to that UE. In short, the baseband node 10 can calculate the quantities but does not, in contrast to the UE, use the indicators (such as CQI, PMI, RI) requesting a specific configuration for those since it does not need to message anyone.

The adapting can comprise determining a degradation of the reception quality indicator, further than what is indicated by the reference metric, as a radio interface degradation. In other words, if a total degradation is X, reflected in the original reception quality indicator being X, and the degradation due to fronthaul packet loss is Y, then the adapted result, being an adapted reception quality indicator, is (X-Y).

The adapting can comprises adjusting the reception quality indicator to correspond to the radio interface degradation.

Looking now to FIG. 5B, only new of modified steps, compared to embodiments illustrated by FIG. 5A will be described.

In an optional provide result to LA (link adaptation) step 48, the signal loss adjuster 1 provides the adapted result to a link adaptation module 79. The link adaptation is thereby performed based on the radio interface degradation, and not (at least to a large extent not) based on fronthaul degradation.

Embodiments presented herein improve the operation of functional split base stations over lossy/lower cost fronthaul links. Improvements are provided for any over-the-air SINR conditions. No changes to standards are needed, neither for 3GPP or for eCPRI. The solution can be implemented using existing nodes and existing interfaces (e.g. using real time control packets in eCPRI). Embodiments presented herein allow the fronthaul links to implemented without over-dimensioning, since errors on the fronthaul will not result in excessive throttling of throughput by link adaptation.

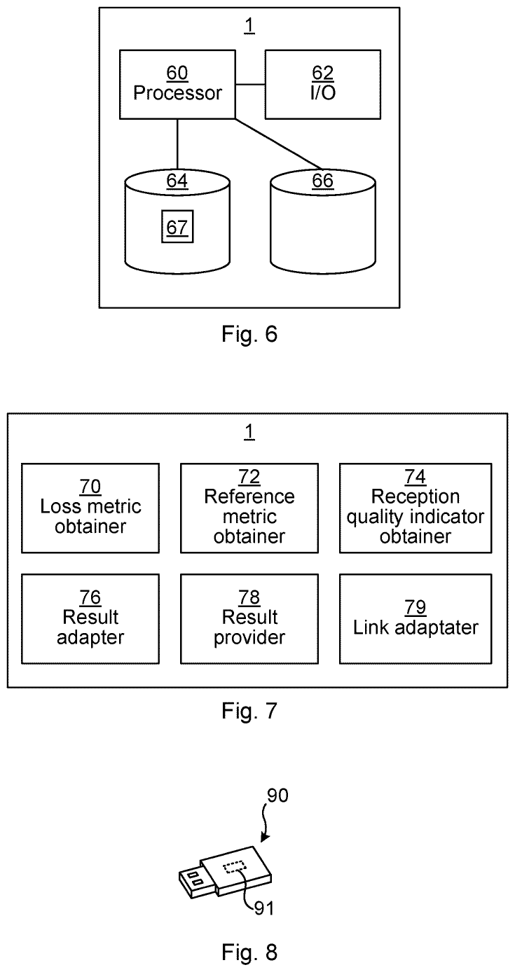

FIG. 6 is a schematic diagram illustrating components of the signal loss adjuster 1 of FIGS. 2A-C. It is to be noted that when the signal loss adjuster 1 is implemented in a host device, one or more of the mentioned components can be shared with the host device. A processor 60 is provided using any combination of one or more of a suitable central processing unit (CPU), graphics processing unit (GPU), multiprocessor, microcontroller, digital signal processor (DSP), etc. capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 5A-B above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The signal loss adjuster 1 further comprises an I/O interface 62 for communicating with external and/or internal entities.

Other components of the signal loss adjuster 1 are omitted in order not to obscure the concepts presented herein.

FIG. 7 is a schematic diagram showing functional modules of the signal loss adjuster 1 of FIGS. 2A-C according to one embodiment. The modules are implemented using software instructions such as a computer program executing in the signal loss adjuster 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 5A-B.

A loss metric obtainer 70 performs functions that corresponds to step 40. A reference metric obtainer 72 performs functions that corresponds to step 42. A reception quality indicator obtainer 74 performs functions that corresponds to step 44. A result adapter 76 performs functions that corresponds to step 46. A result provider 78 performs functions that corresponds to step 48. A link adapter 79 (also called a link adaptation module) is also provided for providing link adaptation.

FIG. 8 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 6. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for adapting to signal loss in a fronthaul link between a baseband node and a radio node of a radio access network the method being performed in a signal loss adjuster, the method comprising:
obtaining a loss metric the loss metric indicating loss of pilot signals over the fronthaul link in a measurement interval;
obtaining a reference metric, based on the loss metric, the reference metric indicating expected impact on at least one reception quality indicator in a receiver based on the loss of pilot signals;
obtaining a reception quality indicator, indicating quality of reception over radio of the pilot signals; and
adapting a result from the reception quality indicator based on the reference metric.

2. The method according to claim 1, wherein the adapting comprises determining a degradation of the reception quality indicator, further than what is indicated by the reference metric, as a radio interface degradation.

3. The method according to claim 2, wherein the adapting comprises adjusting the reception quality indicator to correspond to the radio interface degradation.

4. The method according to claim 1, wherein the obtaining a loss metric is based on a receiver node in the fronthaul link comparing successfully received pilot signals with pilot signals that were scheduled to be received by the receiver.

5. The method according to claim 1, wherein the reference metric is based on any of the following: a signal-to-noise ratio, a channel quality indicator, a rank indicator, a pilot signal received power, and a precoder indicator.

6. The method according to claim 1, further comprising:
providing the adapted result to a link adaptation module.

7. The method according to claim 1, wherein the pilot signal is a downlink transmission, and the obtaining a reception quality indicator comprises obtaining the reception quality indicator from a user equipment.

8. The method according to claim 7, wherein the pilot signal is a channel state information reference signal, CSI-RS, a cell specific reference, CRS, signal or a synchronization signal block.

9. The method according to claim 1, wherein the pilot signal is an uplink transmission, and the obtaining reception quality indicator comprises obtaining the reception quality indicator from the baseband node.

10. The method according to claim 9, wherein the pilot signal is a sounding reference signal, SRS, or a demodulation reference signal, DMRS.

11. A signal loss adjuster for adapting to signal loss in a fronthaul link between a baseband node and a radio node of a radio access network, the signal loss adjuster comprising:
a processor; and
a memory storing instructions that, when executed by the processor, cause the signal loss adjuster to:
obtain a loss metric, the loss metric indicating loss of pilot signals over the fronthaul link in a measurement interval;
obtain a reference metric, based on the loss metric, the reference metric indicating expected impact on at least one reception quality indicator in a receiver based on the loss of pilot signals;
obtain a reception quality indicator, indicating quality of reception over radio of the pilot signals; and
adapt a result from the reception quality indicator based on the reference metric.

12. The signal loss adjuster according to claim 11, wherein the instructions to adapt comprise instructions that, when executed by the processor, cause the signal loss adjuster to determine a degradation of the reception quality indicator, further than what is indicated by the reference metric, as a radio interface degradation.

13. The signal loss adjuster according to claim 12, wherein the instructions to adapt comprise instructions that, when executed by the processor, cause the signal loss adjuster to adjust the reception quality indicator to correspond to the radio interface degradation.

14. The signal loss adjuster according to claim 11, wherein the instructions to obtain a loss metric is based on a receiver node in the fronthaul link comparing successfully received pilot signals with pilot signals that were scheduled to be received by the receiver.

15. The signal loss adjuster according to claim 11, wherein the reference metric is based on any of the following: a signal-to-noise ratio, a channel quality indicator, a rank indicator, a pilot signal received power, and a precoder indicator.

16. The signal loss adjuster according to claim 11, further comprising instructions that, when executed by the processor, cause the signal loss adjuster to:
provide the adapted result to a link adaptation module.

17. The signal loss adjuster according to claim 11, wherein the pilot signal is a downlink transmission, and the instructions to obtain a reception quality indicator comprise instructions that, when executed by the processor, cause the signal loss adjuster to obtain the reception quality indicator from a user equipment.

18. The signal loss adjuster according to claim 17, wherein the pilot signal is a channel state information reference signal, CSI-RS, a cell specific reference, CRS, signal or a synchronization signal block.

19. The signal loss adjuster according to claim 11, wherein the pilot signal is an uplink transmission, and the instructions to obtain a reception quality indicator comprises instructions that, when executed by the processor, cause the signal loss adjuster to obtain the reception quality indicator from the baseband node.

20. (canceled)

21. A computer program product comprising:
a computer program for adapting to signal loss in a fronthaul link between a baseband node and a radio node of a radio access network, the computer program comprising computer program code which, when executed on a signal loss adjuster causes the signal loss adjuster to:
obtain a loss metric, the loss metric indicating loss of pilot signals over the fronthaul link in a measurement interval;
obtain a reference metric, based on the loss metric, the reference metric indicating expected impact on at least one reception quality indicator in a receiver based on the loss of pilot signals;
obtain a reception quality indicator, indicating quality of reception over radio of the pilot signals; and
adapt a result from the reception quality indicator based on the reference metric; and
a computer readable means comprising non-transitory memory in which the computer program is stored.

22. (canceled)
